(19) United States
(12) Patent Application Publication
(10) Pub. No.: US 2025/0333167 A1
(43) Pub. Date: Oct. 30, 2025

(54) SYSTEM AND METHODS FOR DETERMINING RELATIVE FORCES OF AN AIRCRAFT STORE EJECTOR SYSTEM

(71) Applicant: Marvin Engineering Company, Inc., Inglewood, CA (US)

(72) Inventors: Lee Allen Tobias, Laguna Niguel, CA (US); Sohrab John Talebian, Beverly Hills, CA (US)

(21) Appl. No.: 19/189,986

(22) Filed: Apr. 25, 2025

Related U.S. Application Data
(60) Provisional application No. 63/640,589, filed on Apr. 30, 2024.

(51) Int. Cl. B64D 1/16

(52) U.S. Cl. CPC B64D 1/16

(57) ABSTRACT

A method of ejecting a store from an aircraft thereof. The method may include determining one or more parameters and determining a first pressure and a second pressure relative to one another from the determined one or more parameters. The first pressure provides a first force to unlock one or more store releasing connectors and the second pressure provides a second force to eject the store. A system pressure generates a flow of pressurized gas related to one or both of the first and second pressure. The method may include releasing the flow of pressurized gas to actuate the one or more store releasing connectors using the first pressure and symmetrically blocking one or more ejector passages to reduce the system pressure to the second pressure for ejecting the store.

### RELATED APPLICATIONS

This application claims the benefit of U.S. Provisional Patent Application No. 63/640,589 filed on Apr. 30, 2024, entitled “SYSTEM AND METHODS FOR DETERMINING RELATIVE FORCES OF AN AIRCRAFT STORE EJECTOR SYSTEM,” the entire contents of which is incorporated by reference herein and forms a part of this specification for all purposes as if fully set forth herein.

### BACKGROUND

### Field

The disclosure relates generally to aircraft store ejectors. In particular, the disclosure relates to store ejector systems and methods that allow for adjustment of forces acting on a store release connector system and/or a piston ejection system.

### Related Art

Aircraft store ejector systems are commonly used in the aviation industry to allow for transport and/or release of stores carried by aircraft. A typical ejector system may include a plurality of hooks which hold the store to the aircraft wing or fuselage. The system will also often include one or more stabilizers, such as sway-braces, that may be configured to stabilize the store during flight. Many ejector systems also include hydraulic or gas-driven pistons that are used to aid gravity and push the store away from the aircraft upon release of the store from the hooks. Gas-driven pistons are sometimes actuated by “hot” gas generated by pyrotechnic devices. In some systems, gas driven pistons are actuated by “cold” gas, such as compressed air.

### SUMMARY

For purposes of summarizing the disclosure and the advantages achieved over the prior art, certain objects and advantages of the disclosure are described herein. Not all such objects or advantages may be achieved in any particular implementation. Thus, for example, those skilled in the art will recognize that the devices, systems, and methods may be embodied or carried out in a manner that achieves or optimizes one advantage or group of advantages as taught herein without necessarily achieving other objects or advantages as may be taught or suggested herein.

All of these implementations are intended to be within the scope of the devices, systems, and methods herein disclosed. These and other implementations will become readily apparent to those skilled in the art from the following detailed description of the implementations having reference to the attached figures, the devices, systems, and methods not being limited to any particular implementations disclosed.

An implementation may include a method of ejecting a store from an aircraft, including, determining one or more parameters based at least on one or more atmospheric conditions, one or more store properties, and one or more flight conditions prior to ejecting the store; determining a first pressure and a second pressure relative to one another from the determined one or more parameters, the first pressure sufficient to provide a first force to unlock one or more store releasing connectors and the second pressure sufficient to provide a second force to eject the store; determining a system pressure to generate a flow of pressurized gas, wherein the system pressure is related to one or both of the first and second pressure; releasing the flow of pressurized gas to actuate the one or more store releasing connectors using the first pressure; and symmetrically blocking one or more ejector passages of an ejection system to reduce the system pressure to the second pressure for ejecting the store.

In some implementations, a control system is configured to determine the first and second pressures from the one or more parameters.

In some implementations, the control system is on board the aircraft.

In some implementations, the method further includes apportioning the flow of pressurized gas between a first ejector passage and a second ejector passage, wherein the apportioning variably obstructs the first ejector passage and the second ejector passage to cause a first ejector piston to extend at a different rate than a second ejector piston, and wherein the first and second ejector pistons act on the store to eject the store from the aircraft.

In some implementations, the method further includes delaying an opening of a main valve following the actuation of the one or more store releasing connectors.

In some implementations, the symmetrical blocking is configured to allow a reduction in the second pressure acting on or more ejector pistons in fluid communication with the one or more ejector passages while preserving the flow of the first pressure to actuate the one or more store releasing connectors.

In some implementations, the symmetrical blocking reduces the second pressure acting on one or more ejector pistons to reduce a peak force or acceleration acting on the store.

An implementation may include a computer implemented method, performed by an aircraft store ejector system including one or more hardware processors executing program instructions, the method including: detecting one or more flight parameters via one or more sensors; determining from the one or more flight parameters a first pressure sufficient to provide a first force to act on a piston for actuating one or more store releasing connectors and a second pressure sufficient to provide a second force to act on one or more ejector pistons for ejecting a store; selecting a system pressure, wherein the system pressure is related to one or both of the first pressure and the second pressure; and reducing the second pressure received by an ejection system, the ejection system including a first ejector passage and a second ejector passage in fluid communication with a respective one of a first ejector piston and a second ejector piston.

In some implementations, the one or more flight parameters include at least one or more atmospheric conditions, store properties, and one or more flight conditions.

In some implementations, the store properties include a weight of the store.

In some implementations, the method further includes using the first pressure to actuate the one or more store releasing connectors.

In some implementations, the method further includes using the reduced second pressure to eject the store from the aircraft.

In some implementations, the method further includes moving a main valve carried by the piston and configured to selectively separate a source of pressurized gas from the first ejector passage and the second ejector passage, wherein moving the main valve to an open position allows a flow of pressurized gas from the source of pressurized gas to enter the first ejector passage and the second ejector passage.

In some implementations, the method further includes adjusting a control valve, wherein adjusting the control valve includes rotating the control valve about a first axis to alter a position of a first opening with respect to the first ejector passage and a second opening with respect to the second ejector passage to adjust a flow of a pressurized gas provided to the first ejector passage and the second ejector passage.

In some implementations, the system pressure is provided by a pressurized gas source.

An implementation may include a method of ejecting a store from an aircraft, including: detecting one or more flight parameters of the aircraft; determining from the one or more flight parameters a first pressure sufficient to provide a first force for actuating one or more store releasing connectors; determining from the one or more flight parameters a second pressure sufficient to provide a second force for ejecting the store; selecting a system pressure based at least in part on the first force for actuating the one or more store releasing connectors; using the system pressure to actuate the one or more store releasing connectors; reducing the system pressure to a reduced pressure based at least in part on the second force for ejecting the store; and using the reduced pressure to eject the store from the aircraft.

In some implementations, a control system is configured to determine the first and second pressures from the one or more flight parameters.

In some implementations, the control system is on board the aircraft.

In some implementations, the one or more flight parameters include at least one or more atmospheric conditions, store properties, and one or more flight conditions.

In some implementations, the store properties include a weight of the store.

In some implementations, the method further includes apportioning the reduced pressure between a first ejector passage and a second ejector passage, wherein the apportioning variably obstructs the first ejector passage and the second ejector passage to cause a first ejector piston to extend at a different rate than a second ejector piston, and wherein the first and second ejector pistons act on the store to eject the store from the aircraft.

In some implementations, the method further includes delaying an opening of a main valve following the actuation of the one or more store releasing connectors.

In some implementations, reducing the system pressure to a reduced pressure allows a reduction in the second pressure acting on or more ejector pistons in fluid communication with one or more ejector passages while preserving a flow of the first pressure to actuate the one or more store releasing connectors.

In some implementations, the reduced pressure reduces the second pressure acting on the one or more ejector pistons to reduce a peak force or acceleration acting on the store.

An implementation may include a method of ejecting a store from an aircraft, including: determining a system pressure sufficient to provide a first force for actuating one or more store releasing connectors; using the system pressure to actuate the one or more store releasing connectors; reducing the system pressure to a reduced pressure; and using the reduced pressure to eject the store from the aircraft.

In some implementations, the method further includes detecting one or more flight parameters, wherein the system pressure is determined from the one or more flight parameters.

In some implementations, a control system is configured to determine the system pressure from the one or more flight parameters.

In some implementations, the control system is on board the aircraft.

In some implementations, the one or more flight parameters include at least one or more atmospheric conditions, store properties, and one or more flight conditions.

In some implementations, the store properties include a weight of the store.

In some implementations the method further includes apportioning the reduced pressure between a first ejector passage and a second ejector passage, wherein the apportioning variably obstructs the first ejector passage and the second ejector passage to cause a first ejector piston to extend at a different rate than a second ejector piston, and wherein the first and second ejector pistons act on the store to eject the store from the aircraft.

In some implementations, reducing the system pressure to a reduced pressure acting on the first and second ejector pistons while preserving a flow of the first pressure to actuate the one or more store releasing connectors.

In some implementations, the reduced pressure reduces the system pressure acting on the one or more ejector pistons to reduce a peak force or acceleration acting on the store.

In some implementations, the method further includes delaying an opening of a main valve following the actuation of the one or more store releasing connectors.

### BRIEF DESCRIPTION OF THE DRAWINGS

These and other features, aspects, and advantages of the disclosure are described with reference to drawings of certain implementations, which are intended to illustrate, but not to limit, the present disclosure. It is to be understood that the accompanying drawings, which are incorporated in and constitute a part of this specification, are for the purpose of illustrating concepts disclosed herein and may not be to scale.

The present aircraft store ejector system is described herein with reference to drawings of preferred implementations, which are intended to illustrate and not to limit the present invention.

FIG. 1 illustrates a pneumatic circuit representation of an implementation of the aircraft store ejector system.

FIG. 2 illustrates a cross-sectional view of a release valve and first and second ejector pistons of an implementation of the aircraft store ejector system.

FIG. 3A illustrates a side view of portions of the aircraft store ejector system.

FIG. 3B illustrates a cross-sectional side view of the aircraft store ejector system of FIG. 3A.

FIG. 3C illustrates a cross-sectional view of the aircraft store ejector system of FIG. 3A taken along the line 3C-3C of FIG. 3A.

FIG. 4A illustrates a cross-sectional view of the release valve in a ready to fire position.

FIG. 4B illustrates an enlarged view of a portion of the release valve indicated by the line 4B-4B in FIG. 4A.

FIG. 4C illustrates a cross-sectional view of the release valve of FIG. 4A in a first position.

FIG. 4D illustrates a cross-sectional view of the release valve of FIG. 4A in a second position.

FIG. 4E illustrates a cross-sectional view of the release valve of FIG. 4A in a third position.

FIG. 5A illustrates a perspective view of an implementation of a pitch control valve.

FIG. 5B illustrates a perspective view of a portion of an implementation of a pitch control valve, which is a modification of the implementation illustrated in FIG. 5A.

FIG. 6 illustrates a pneumatic circuit representation of an implementation of the aircraft store ejector system, which is another modification of the system of FIGS. 1-6.

FIG. 7 illustrates a cross-sectional view of an implementation of a release valve assembly where a portion of the piston housing is rotated to an occluding position.

FIG. 8 is a flow diagram of a method for determining relative forces for ejecting a store of an aircraft.

### DETAILED DESCRIPTION

Although several implementations, examples, and illustrations are disclosed below, it will be understood by those of ordinary skill in the art that the devices, systems, and methods described herein extend beyond the specifically disclosed implementations, examples, and illustrations and includes other uses of the devices, systems, and methods and obvious modifications and equivalents thereof. Implementations are described with reference to the accompanying figures, wherein like numerals refer to like elements throughout. The terminology used in the description presented herein is not intended to be interpreted in any limited or restrictive manner simply because it is being used in conjunction with a detailed description of some specific implementations of the devices, systems, and methods. In addition, implementations may comprise several novel features. No single feature is solely responsible for its desirable attributes or is essential to practicing the devices, systems, and methods herein described.

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of implementations.

Several implementations of an improved aircraft store ejector system and individual components of the ejector system are disclosed herein. The implementations disclosed are often described in the context of an ejector system for use on the wing and/or fuselage of an aircraft.

For the purpose of providing context to the present disclosure, it is noted that there are essentially two types of cold gas energized ejection systems currently in service. Type A Systems are ground recharged bottle systems wherein an onboard pressure vessel local to the ejectors is charged while the aircraft is on the ground either while the vessel is installed or when the vessel has been removed such that it may be recharged remote from the air vehicle. Variations in ambient temperature or system leakage will cause the pressure within the on-board vessel to vary, leading to potentially unacceptable and/or unsafe changes in the overall ejection system performance.

Type B Systems are integral pressure intensifier systems wherein an onboard “multi-stage” pressure intensifier (which may be a compressor) is used to charge a bottle, which is local to the ejectors. The pressure intensifier charges the bottle from atmospheric pressure to operating pressure and then maintains optimal pressure across wide variations of system temperature etc.

Whereas such systems offer relative freedom from ground servicing, the ejection system's need for clean dry gas requires that pressure intensifier-based systems of this type incorporate special filters, either disposable or self-regenerating, whose efficacy and ultimate life are a function of atmospheric air quality. Further, pressure intensifier performance and life are adversely affected by increases in aircraft operational altitude—e.g., the pressure intensifier must work “harder” to reach optimal ejector pressure when altitude increases and local atmospheric pressure decreases. Also, the actual quality of the delivered air is unknown unless a means of purity monitoring is incorporated, adding further to the complexity of such systems.

Additionally, carriage and ejector release units for airborne stores generally use stored high pressure cold gas or pyrotechnic cartridge-generated hot gas to pressurize and effect the store separation sequence by first operating linkages to disengage the carriage hooks from the store suspension lugs and then aiding gravity by forcing vertically extending pistons to thrust the store away from the aircraft.

Generally, the maneuvering of the aircraft and the resulting airflow conditions at store release combine to generate forces on the departing store which, unless counteracted, would produce an unsafe and/or unstable separation of the store. Both are undesirable, in that the former presents an aircraft collision hazard and the latter could result in a loss of accuracy or range if the released store is a weapon.

A high total ejection force (and hence ejection velocity) provides one component of a solution for safe separation. However, airflow and maneuver forces generating excessive store pitch rotations need to be counteracted by opposing ejector forces acting differentially through the forward and rear ejector pistons. The term for this function is pitch control and it is generally achieved by adjusting the sizes of the orifices in the gas transfer paths leading to the two ejector positions such that the forward and aft forces can be varied in relation to one another. This adjustment typically takes place on the ground prior to the flight or mission using predictions of the actual flight and store separation conditions. Because the actual conditions may vary significantly from the predicted conditions, the pitch adjustment may often be less than optimal.

Upon release of the store from the aircraft, it is often required that the high pressure gas within the ejector system (e.g., within ejector pistons and corresponding fluid paths) be vented out of the system to allow retraction of the ejector pistons. Many current systems address this problem by placing vents at or near the extended ends of the pistons themselves. When the pistons are extended, the vents are exposed and vent the remaining high pressure gas to atmosphere. This method may be disadvantageous in that it requires the entire internal volume of the pistons to be filled before extension begins and, thus, a larger volume of pressurized gas must be vented prior to retraction. Furthermore, in such systems, the use of a plurality of spring or other retraction mechanisms is required to retract the ejector pistons. These retraction mechanisms may add weight to the piston assemblies. Extra weight in the piston assemblies not only adds overall weight to the aircraft, but also creates additional stress upon the airframe where the ejector assemblies are attached.

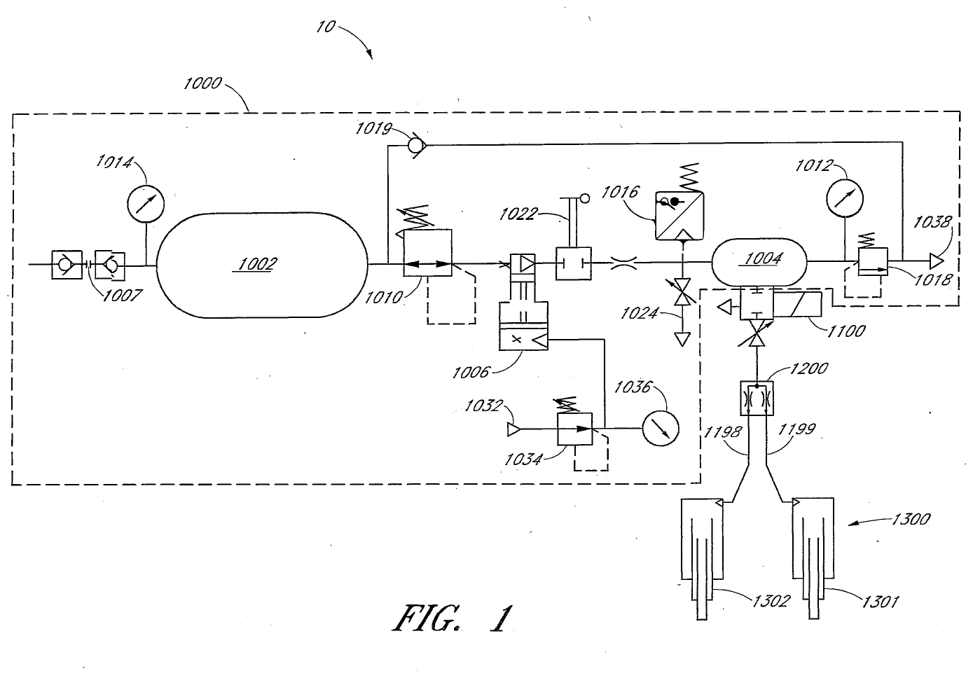

FIG. 1 illustrates an aircraft store ejector system 10 which may include a gas re-pressurization system 1000. The system 10 preferably is provided on an associated aircraft and is controlled by a suitable control system to release a store of any type. The control system may include any suitable sensors, processors, actuators or other typical or desirable components in addition to those illustrated herein, as will be appreciated by those skilled in the art. The control system may be a dedicated system or may be integrated with other control systems of the aircraft. The ejector system 10 may be controlled by a pilot or other crew member aboard the aircraft or may be controlled from a location remote from the aircraft.

The illustrated re-pressurization system 1000 includes a remote reservoir 1002 and a local reservoir 1004. In some implementations, the re-pressurization system includes a pressure intensifier 1006 located between the remote reservoir 1002 and the local reservoir 1004. The ejector system 10 may further include a release valve 1100 configured to selectively introduce high pressure gas from the local reservoir 1004 to an ejection system 1300, in some cases through an optional pitch control valve 1200. The pitch control valve 1200 may be configured to distribute high pressure gas from the local reservoir 1004 to one or more ejector passages 1198, 1199. The pitch control valve 1200 may be configured to vary the distribution of high pressure gas between the one or more ejector passages 1198, 1199 (e.g., one ejector passage may receive more or less high pressure gas than another ejector passage). The ejector passages 1198, 1199 may be configured to allow high pressure gas to pass from the pitch control valve 1200 to the ejection system 1300. The ejection system 1300 may include one or more ejector pistons 1301, 1302. Preferably, the one or more ejector pistons 1301, 1302 are configured to extend upon introduction of high pressure gas into ejection system 1300. Although each of the gas re-pressurization system 1000, the release valve 1100, the pitch control valve 1200, and the ejection system 1300 are described herein in the context of their interrelationships, it should be noted that each of the systems/devices 1000, 1100, 1200, 1300 may be combined with systems and devices other than those described herein. For example, the re-pressurization system 1000 may be used with store release systems that do not include a pitch control valve 1200 or with store release systems that include pitch control valves other than the valve 1200 disclosed herein. Similarly, the re-pressurization system 1000 and/or pitch control valve 1200 may be used with ejection systems other than the ejection system 1300 disclosed herein.

In some implementations, as explained above, the gas re-pressurization system 1000 includes a remote reservoir 1002. Preferably, the remote reservoir 1002 has a larger volume than the local reservoir 1004 (which is discussed below). In some such implementations, the remote reservoir 1002 may hold more than twice the volume of the local reservoir 1003. In some arrangements, the remote reservoir 1002 may be configured to feed multiple local reservoirs 1004, each of which supply pressurized gas to at least one associated ejection system 1300. In such cases, the remote reservoir 1002 may be capable of holding a volume that is several multiples of a single local reservoir 1004. Such an arrangement may permit recharging of the local reservoirs 1004 to allow multiple store ejections. It is presently contemplated that, at least in some implementations, the remote reservoir 1002 will be used primarily to “top-off” the pressure of one or more local reservoirs 1004, as opposed to completely refilling the local reservoirs 1004. Therefore, in some implementations, the volume of the remote reservoir 1002 will be less than the combined volume of the local reservoirs 1004. As will be appreciated by those of skill in the art, a single aircraft may employ multiple ejector systems 10, including multiple remote reservoirs 1002 and multiple local reservoirs 1004. Such systems 10 may be controlled by a single control system or individual control systems and may be entirely independent or may share one or more components.

In some implementations, as explained above, the re-pressurization system 1000 includes a local reservoir 1004, and may include multiple local reservoirs 1004. The local reservoir 1004 may be configured to provide high pressure gas to the ejection system 1300 via the release valve 1100 and/or pitch control valve 1200. In some implementations, the remote reservoir 1002 is configured to provide high pressure gas to the local reservoir 1004 while, before, and/or after the local reservoir 1004 provides high pressure gas to the ejection system 1300.

Both the remote reservoir 1002 and the local reservoir 1004 may be initially ground charged with high pressure purified gas (e.g., air, nitrogen, another suitable gas, or any combination thereof) from a source external to the aircraft. The remote reservoir 1002 and/or local reservoir 1004 may be configured to be filled by a source within the aircraft (e.g., an onboard compressor or other pressurized gas source). In some implementations, the remote reservoir 1002 and/or the local reservoir 1004 are separable from the re-pressurization system 1000. In such implementations, the remote reservoir 1002 and/or the local reservoir 1004 may be charged while disconnected from the system 1000 and/or while removed from the aircraft.

In some implementations, changes in altitude and/or temperature may lower the pressure within one or both of the remote reservoir 1002 and the local reservoir(s) 1004. In such situations, the local reservoir(s) 1004 may be recharged via the remote reservoir 1002. In some implementations, the pressure intensifier 1006 may aid in the recharging of the local reservoir(s) 1004. In some arrangements, the volume of the remote reservoir 1002 is selected to allow multiple (e.g., about 5-15) ejection cycles for the local reservoir 1004 before recharging is necessary.

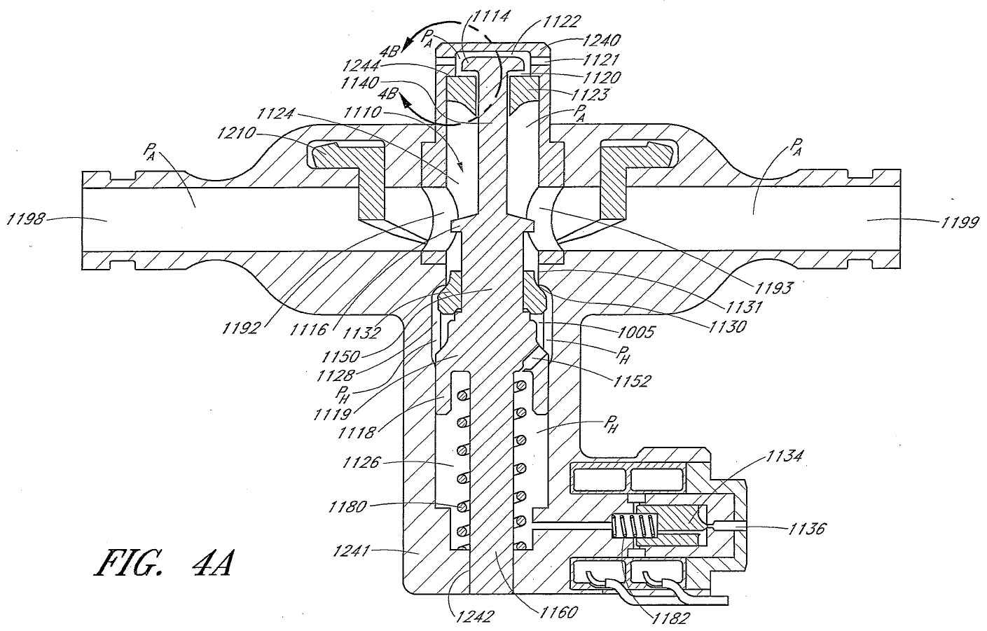

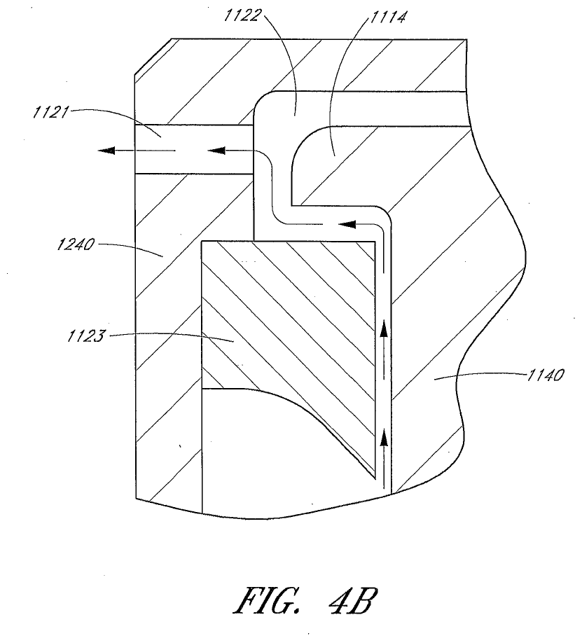

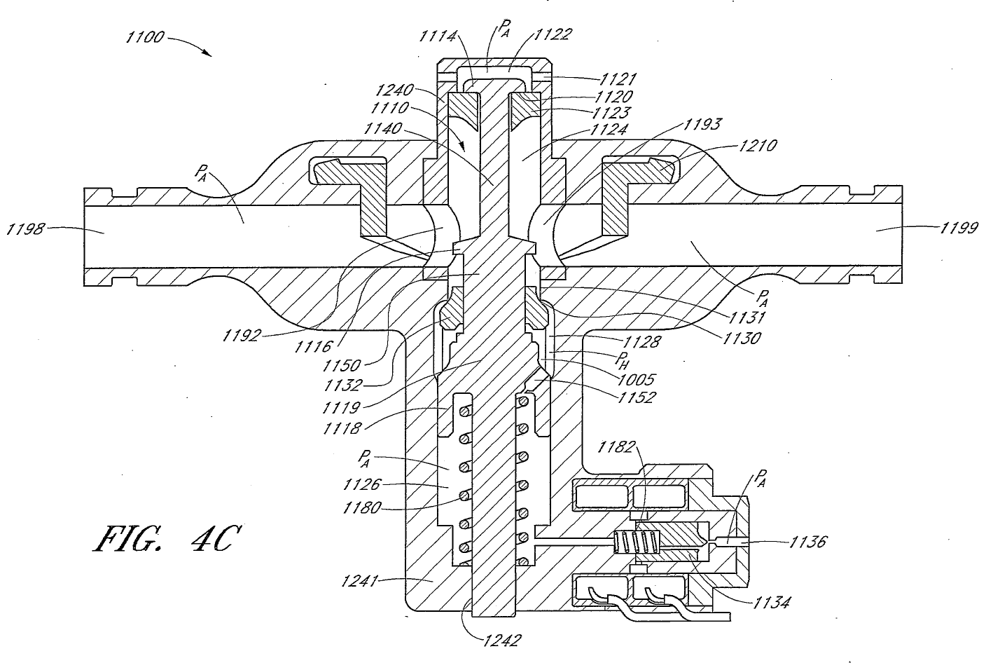

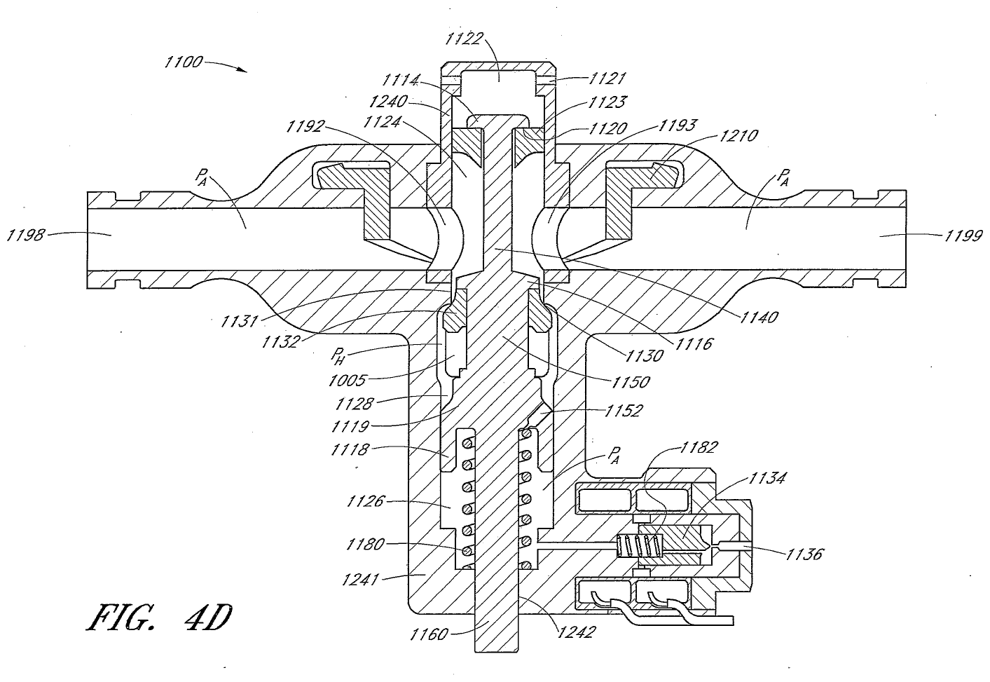

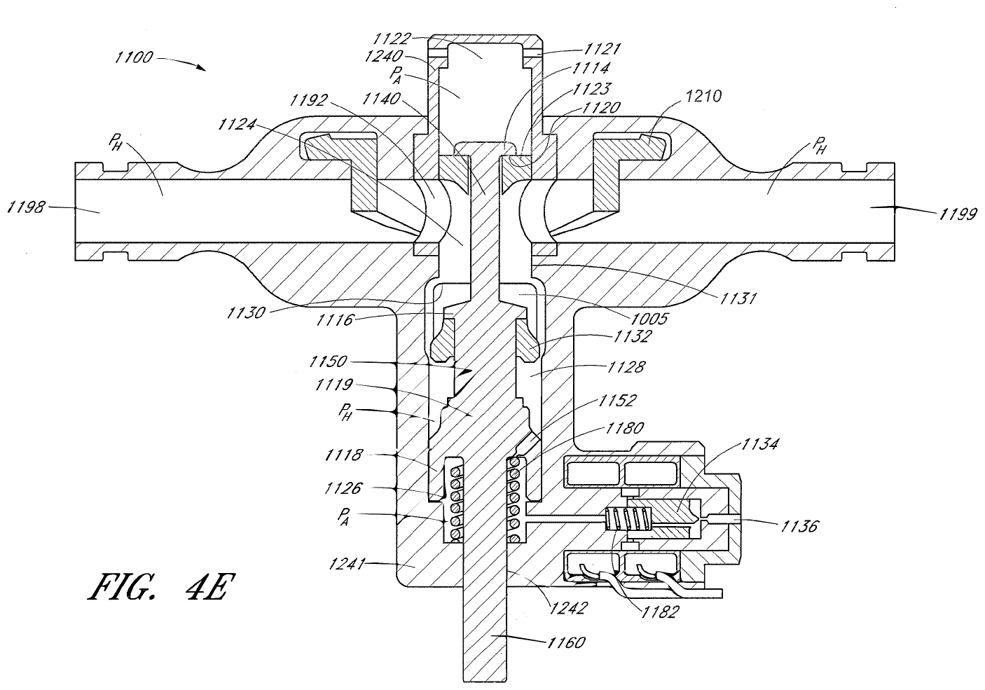

As explained above, a release valve 1100 may be used to selectively release high pressure gas from the local reservoir 1004 to the ejection system 1300. The release valve 1100 may be of any suitable type or construction. As illustrated in FIGS. 4A-4E, the illustrated release valve 1100 includes a housing body that may include an upper piston housing 1240, a lower piston housing 1241, a valve body or valve piston 1110, a vent valve 1120, a main valve 1130, and/or a firing valve 1136. In some implementations, the valve piston 1110 may be a servo piston. As illustrated, the valve piston 1110 may include one or more axial and/or radial sections having cross-sectional shapes configured to accomplish one or more specific functions. For example, the valve piston 1110 may include a top portion 1140 having a generally cylindrical shape, an axial centerline, an axial length, and an outer surface. The outer surface of the top portion 1140 may be constant along the axial length of the first portion. In some implementations, the top portion 1140 may include flared, stepped, and/or tapered sections along its axial length to block or allow flow, as necessary or desired. In some implementations, the valve piston 1110 includes a cap portion 1114 connected to the top (e.g., toward the top of FIG. 4A) of the top portion 1140. The cap portion 1114 may have a generally cylindrical shape, an axial centerline, an outer surface, and an axial length. In some implementations, the cap portion 1114 is coaxial with the top portion 1140. In some such implementations, a cross-sectional dimension of the outer surface of the cap portion 1114 is greater than a cross-sectional dimension of the outer surface of the top portion 1140.

The valve piston 1110 may include an intermediate portion 1150. The intermediate portion 1150 may have a generally cylindrical shape, an axial centerline, an axial length, and an outer surface. In some implementations, the intermediate portion 1150 is connected to and/or coaxial with the top portion 1140. In some implementations, the intermediate portion 1150 may have flared, stepped, and/or tapered sections along its axial length to block or allow flow, as necessary or desired. For example, the intermediate portion 1150 may include an expanded portion 1119. The cross-sectional dimension of the outer surface of the expanded portion 1119 may be larger than the cross-sectional dimension of the outer surface of the intermediate portion 1150 and, in some implementations, the expanded portion 1119 may have an outer surface that substantially or entirely fills an interior portion of the lower piston housing 1241 in the vicinity of the expanded portion 1119.

In some implementations, the valve piston 1110 includes a bottom portion 1160. The bottom portion 1160 may extend from the intermediate portion 1150 in a direction opposite the top portion 1140. The bottom portion 1160 may have a generally cylindrical shape, and axial centerline, an axial length, and an outer surface. In some implementations, the bottom portion 1160 may extend through a port 1242 in the lower piston housing 1241. Although the portions of the valve piston 1110 have been described as having generally cylindrical shapes, it is anticipated that other suitable shapes may be utilized for one or more of the portions of the valve piston 1110. For example, one or more portions of the valve piston 1110 could have generally oval-shaped outer cross-sectional shapes, rectangular outer cross-sectional shapes, or any other suitably-shaped outer cross-sections. Furthermore, unless indicated otherwise, the terms “cylinder” or “cylindrical” are used herein in accordance with their ordinary meaning, which have a broad definition and encompass a closed loop of any cross-sectional shape that is extruded along an axis to define a length. A cylinder may be solid or hollow in cross-section.

In some implementations, the vent valve 1120 may be formed through the use of a floating poppet 1123. The floating poppet 1123 may have an inner surface, an outer surface, a central axis, and an axial length. The outer surface of the floating poppet 1123 may be configured fit snuggly within an inner surface of the upper piston housing 1240. In some implementations, the floating poppet 1123 may be configured to slidably engage with the inner wall of an intermediate section 1124 (described below) of the upper piston housing 1240. Preferably, a cross-sectional dimension of the inner surface of the floating poppet 1123 is larger than a cross-sectional dimension of the outer surface of the top portion 1140 of the valve piston 1110 so that a passage is defined therebetween to permit fluid flow. In some such implementations, the floating poppet 1123 is coaxial with the top portion 1140 of the valve piston 1110 and is positioned between the cap portion 1114 and intermediate portion 1150 of the valve piston 1110. The cap portion 1114 may be configured to have an outer cross-sectional dimension that is larger than the inner cross-sectional dimension of the floating poppet 1123 so that the floating poppet 1123 may be moved in one direction (e.g., downward in FIGS. 4A-4E) by the valve piston 1110. In some implementations, the floating poppet 1123 may be normally biased in the upward direction (e.g., toward the top of FIGS. 4A-4E) by any suitable arrangement, such as system pressure or a biasing member (e.g., a spring). Preferably, upward movement of the floating poppet 1123 is limited by a protrusion 1244, such as a shoulder or other stop surface, near the top of the upper piston housing 1240.

The vent valve 1120 may be configured to transition to an open configuration when there is clearance between the upper surface of the floating poppet 1123 and the lower surface of the cap portion 1114. In such configurations, gas and/or other fluids may pass through the passage between the inner surface of the floating poppet 1123 and the outer surface of the top portion 1140 of the valve piston 1110 and through the space between the upper surface of the floating poppet and the lower surface of the cap portion 1114, as illustrated in FIG. 4B. The upper piston housing 1240 may include one or more vent ports 1121 that may allow gas to vent out from the interior of the upper piston housing 1240 when the vent valve 1120 is in the opened configuration. Advantageously, such an arrangement provides a simple means for venting the system pressure in a non-firing position or mode.

As illustrated, the main valve 1130 may be formed through the use of a valve body or main valve poppet 1132. The main valve poppet 1132 may have a generally annular shape, an axial centerline, an inner surface, and an outer surface. In some implementations, the outer surface of the main valve poppet 1132 includes one or more tapered, flared, and/or stepped portions. The main valve poppet 1132 may be configured such that the inner surface of the main valve poppet 1132 is sized to fit snugly around at least a portion of the intermediate portion 1150 of the valve piston 1110. As illustrated in FIG. 4A, the main valve poppet 1132 may be tapered such that a cross-sectional dimension of the outer surface of the main valve poppet 1132 is smaller at the top of the main valve poppet 1132 than at the bottom of the main valve poppet 1132. In some such configurations, the lower piston housing 1241 may have a reduced inner portion that defines a valve seat 1131 generally near the top of the lower piston housing 1241. The valve seat 1131 of the lower piston housing 1241 may be configured to be greater than the upper outer cross-sectional dimension of the main valve poppet 1132 and smaller than the lower outer cross-sectional dimension of the main valve poppet 1132. In some such configurations, the main valve poppet 1132 may form a substantially fluid-tight seal with the valve seat 1131 of the lower piston housing 1241. The fluid-tight seal may be released when the main valve poppet 1132 is moved downward and away from the reduced cross-section area 1131 of the lower piston housing 1241. Release of the fluid-tight seal results in an opening of the main valve 1130, thereby permitting fluid communication between sections of the release valve 1100 above the main valve 1130 and sections of the release valve 1100 below the main valve 1130.

In some implementations, the space within the release valve 1100 may be characterized into one or more sections. A vent section 1122 is defined by the space within the release valve 1100 above (e.g., toward the top of FIGS. 4A-4E) the vent valve 1120. An intermediate section 1124 is defined as the space between the main valve 1130 and the vent valve 1120. The intermediate section 1124 may be in continuous fluid communication with the ejector passages 1198, 1199 throughout the stroke of the valve piston 1110 via one or more ejector passage openings 1192, 1193. A main valve section 1128 is defined as the space between the main valve 1130 and the expanded portion 1119 of the valve piston 1110. In some implementations, the main valve section 1128 is in communication with the local reservoir 1004. In some such implementations, the main valve section 1128 may be maintained at the same or a similar pressure as the local reservoir 1004 via a valve window 1005. The space between the expanded portion 1119 and the firing valve 1136 is defined as the firing section or space 1126. In some implementations, a resilient member 1180 may be housed within the firing space 1126. The resilient member 1180 may be a compression spring or other resilient object configured to apply an upward force on the lower side of the expanded portion 1119.

According to some implementations, the release valve 1100 may begin an ejection cycle in a ready to fire configuration, as illustrated in FIG. 4A. In such a configuration, the firing valve 1136 is in a closed position. In some implementations, the firing valve 1136 is closed by a valve body or plug 1134. Furthermore, the intermediate section 1124 is isolated from the main valve section 1128 by the main valve 1130 and/or the main valve poppet 1132 when the release valve 1100 is in the ready to fire configuration. In some implementations, the main valve section 1128 is in fluid communication with the firing space 1126 via a throttled port 1152. The throttled port 1152 may be positioned within the expanded portion 1119 of the valve piston 1110. Fluid communication between the firing space 1126 and the main valve section 1128 may allow for a buildup of high pressure (“PH” as noted in the figures) gas within the firing space 1126 when the local reservoir 1004 is charged with high pressure gas. The throttled port 1152 preferably regulates (e.g., increases) the amount of time required for the equalization of pressure between the main valve section 1128 and the firing section 1126 such that unequal pressures may be implemented to cause or assist movement of the valve piston 1110.

When the vent valve 1120 is in the open configuration, as illustrated in FIG. 4A, the ejector passages 1198, 1199, the intermediate section 1124 of the release valve 1100, and the upper portion of the release valve 1100 are in communication with ambient via the vent ports 1121. This keeps the ejector passages 1198, 1199, the intermediate section 1124 of the release valve 1100, and the upper portion of the release valve 1100 at ambient pressure (“PA” as noted in the figures) while the vent valve 1120 is in the open configuration. Any intentional or incidental leakage of high pressure gas from the main valve section 1128 through the main valve 1130 into the intermediate space 1124 may be vented to atmosphere when the vent valve 1120 is in the open configuration, thereby preventing inadvertent pressurization of the ejector passages 1198, 1199 and/or ejection system 1300.

In some implementations, pressurization of the firing space 1126 with high pressure gas may help maintain the release valve 1100 in the ready to fire configuration. For example, in some implementations, the cross-sectional dimension of the outer surface of the bottom portion 1160 of the valve piston 1110 is smaller than the cross-sectional dimension of the outer surface of the intermediate portion 1150. In such an implementation, the projection of the upper surface of the expanded portion 1119 onto a plane perpendicular to the axial centerline of the expanded portion 1119 is smaller than the projection of the lower surface of the expanded portion 1119 onto the same plane. As a result, in situations where the pressure above and below the expanded portion 1119 is equal, a greater axial pressure force would be exerted upon the lower side of the expanded portion 1119 than on the upper side of the expanded portion 1119 due to the increased area upon which the axial pressure force would be acting. Such an imbalance of force would result in upward movement of the expanded portion 1119 and, in implementations where the expanded portion 1119 is fixedly attached to the valve piston 1110, the valve piston 1110. In some implementations, the imbalance of force described above is augmented by spring force provided to the underside of the expanded portion 1119 by the resilient member 1180.

In some implementations, upward movement of the expanded portion 1119 and/or the valve piston 1110 may be limited by contact between the expanded portion 1119 and the main valve poppet 1132 when the main valve 1130 is in the closed configuration. In some implementations, upward movement of the valve piston 1110 could be additionally or alternatively limited by contact between the upper surface of the cap portion 1114 and the lower surface of the top of the upper piston housing 1240. In some implementations, upward movement of the valve piston 1110 may be limited by contact between the expanded portion 1119 and the main valve poppet 1132 such that the cap portion 1114 is inhibited from contacting the lower surface of the top of the upper piston housing 1240, as illustrated in FIG. 4A

Referring to FIG. 4C, the ejection cycle may be initiated by actuating or moving the plug 1134 to open the firing valve 1136. The plug 1134 may be actuated by any suitable arrangement. For example, the firing valve 1136 may be a solenoid or solenoid-type valve. Upon opening of the firing valve 1136, the high pressure gas within the firing space 1126 may evacuate through the firing valve 1136. Preferably, the firing valve 1136 is configured to allow gas to escape to ambient at a rate higher than the rate at which the throttled port 1152 allows gas to travel from the main valve section 1128 to the firing space 1126. Accordingly, the pressure within the firing space 1126 is lowered to at or near ambient pressure (or to a relative pressure low enough to cause or permit movement of the valve piston 1110). Because the main valve section 1128 is maintained at or near (e.g., just below) the pressure of the local reservoir 1004, an imbalance of the axial forces on the top and bottom of the expanded portion 1119 is created. Because the pressure within the local reservoir 1004 is higher than the pressure within the firing space 1126, the axial forces on the expanded portion 1119 will cause the valve piston 1110 to move downward. That is, when the pressure in the local reservoir 1004 is high enough to create a downward force upon the expanded portion 1119 greater than upward force created by the ambient (or other) pressure and spring force beneath the expanded portion 1119, the valve piston 1110 will move downward. Downward motion of the valve piston 1110 causes the cap portion 1114 to contact the floating poppet 1123. Contact between the cap portion 1114 and the floating poppet 1123 closes the vent valve 1120, as illustrated in FIG. 4C.

Further movement of the valve piston 1110 in the downward direction may cause a portion (e.g., the bottom portion 1160) of the valve piston 1110 to actuate a mechanism which releases store securing features holding the store to the aircraft. The store securing features may include sway braces configured to stabilize the store. In some implementations, the store securing features are hooks holding the store to the aircraft. In some implementations, the valve piston 1110 includes a feature that engages the main valve poppet 1132. In the illustrated arrangement, the feature is a shoulder 1116. In some implementations, the shoulder 1116 is annular and may be broken into a plurality of radial projections from the valve piston 1110. The shoulder 1116 may be positioned at the border between the top portion 1140 and intermediate portion 1150 of the valve piston 1110. Downward movement of the valve piston 1110 may bring the shoulder 1116 into contact with the main valve poppet 1132, as illustrated in FIG. 4D. Thus, the valve piston 1110 and main valve poppet 1132 create a lost motion mechanism. The distance between the shoulder 1116 and the main valve poppet 1132 provides a delay in actuation of the main valve poppet 1132 and, as described below, the release of pressurized gas to the ejection system 1300 to ensure that the store securing features have been released.

Referring to FIG. 4E, further movement of the valve piston 1110 in the downward direction may cause the main valve poppet 1132 to move away from the valve seat 1131 of the lower piston housing 1241. The downward movement of the valve piston 1110 may be limited by a stop surface, which may be defined by the end of an axial extension 1118 from the bottom of the expanded portion 1119. For example, the axial extension 1118 may be configured to come into contact with a shoulder or other surface feature of the lower cap housing 1241 when the valve piston 1110 has moved in an opening direction (e.g., downward in FIGS. 4A-4E) a pre-determined distance, as illustrated in FIG. 4E. Disengagement of the main valve poppet 1132 from the reduced cross-section area 1131 opens the main valve 1130 and creates fluid communication between the valve window 1005 and the intermediate section 1124. Such fluid communication allows high pressure gas from the local reservoir 1004 to enter the ejector passages 1198, 1199. Entry of high pressure gas into the ejector passages 1198, 1199 may actuate the ejection system 1300. Actuation of the ejection system 1300 may cause the ejector pistons 1301, 1302 to extend and eject the store from the aircraft.

Upon closure of the firing valve 1136, the pressure of the gas in the firing space 1126 is raised via migration of high pressure gas from the main valve section 1128 to the firing space 1126 through the throttled port 1152. As the pressure in the firing space 1126 is raised, the axial pressure force upon the underside of the expanded portion 1119 is raised. The valve piston 1110 may be configured to move upward when the axial force on the bottom of the expanded portion 1119 caused by the resilient member 1180 and the axial pressure overcomes the axial pressure force exerted downward upon the top of the expanded portion 1119. Additionally, the high pressure within the intermediate section 1124 may create an upward axial force upon the bottom of the floating poppet 1123. The upward force upon the bottom of the floating poppet 1123 may provide an additional force tending to cause the valve piston 1110 to move in the upward direction. In some implementations, the valve piston 1110 is configured to move in the upward direction until the expanded portion 1119 comes into contact with the main valve poppet 1132 and the main valve poppet 1132 comes into contact with the reduced inner cross-section area 1131. Such movement may result in disengagement of the cap portion 1114 from the floating poppet 1123, opening the vent valve 1120. As explained above, opening of the vent valve 1120 may vent the ejector passages 1198, 1199 and the ejection system 1300. Venting of the ejection system 1300 may cause the ejector pistons 1301, 1302 to return to a retracted configuration, as described below.

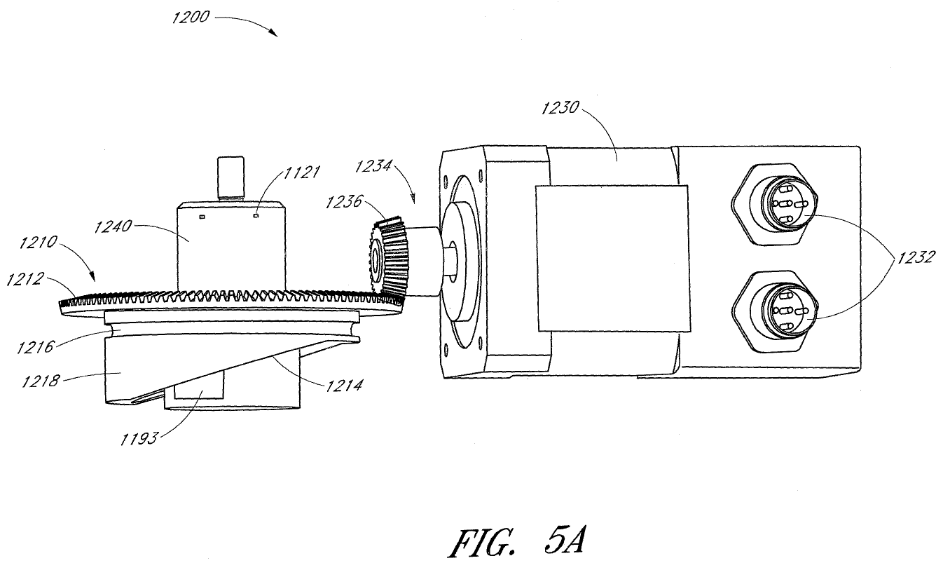

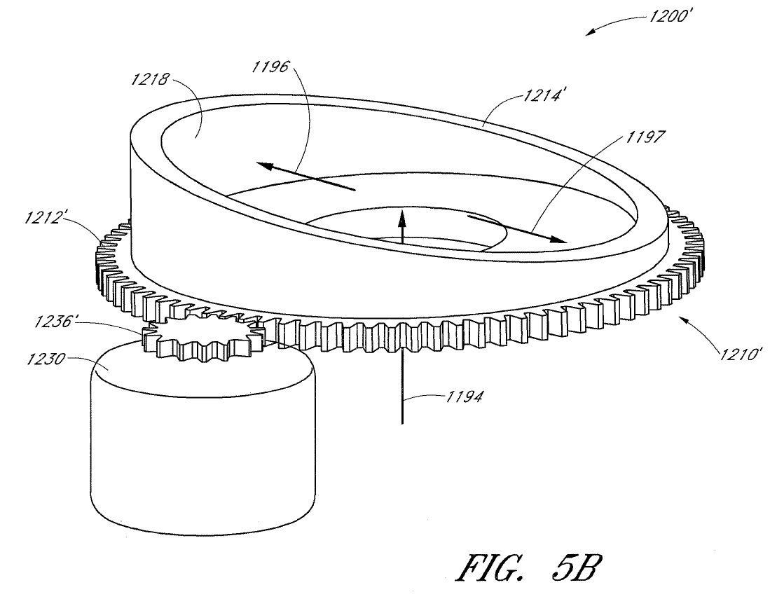

In some implementations, as discussed above, the aircraft store ejector system 10 may include a pitch control valve 1200 that apportions the flow of pressurized gas between multiple flow passages, such as the ejector passages 1198, 1199. Referring to FIG. 5A, the pitch control valve 1200 may include a rotational valve body, such as a carousel 1210. The carousel 1210 may include an annular occluding portion 1218. In some implementations, the occluding portion 1218 is an annular obstruction wall, preferably which is variable in height along at least a portion of or its entire periphery or circumference. In some implementations, an end surface (e.g., the bottom surface 1214) of the occluding portion 1218 may have a ramped configuration, such that a maximum height of the occluding portion 1218 is located approximately 180° from the minimum height of the occluding portion 1218. As illustrated in FIGS. 4A-4E, a portion of the carousel 1210 may be positioned between the valve window 1005 and the ejector passages 1198, 1199. Preferably, the occluding portion 1218 of the carousel 1210 obstructs the flow of high pressure gas from the valve window 1005 to the ejector passages 1198, 1199 when the main valve 1130 is opened. When oriented as shown in FIG. 4A, the occluding portion 1218 is obstructing ejector passage 1198 to the same extent that it is occluding ejector passage 1199. The carousel may include a groove 1216 (FIG. 5A) configured to receive a seal member (not shown) to create a substantial seal with the housing that supports the carousel 1210.

In some implementations, the carousel 1210′ may be oriented such that an end surface of the occluding member 1218′ that defines the variable height is the upper surface, as illustrated in FIG. 5B. In such implementations, the release valve flow 1194 may enter the carousel 1210′ from beneath the carousel 1210′. The release valve flow 1194 may then be redirected toward the occluding member 1218′ and on to the ejector passages 1198, 1199, as indicated by arrows 1196, 1197. In other respects, the structure, operation and function of the carousel 1210′ may be the same as or similar to the carousel 1210 of FIG. 5A.

In some cases, the entire end surface is planar (e.g., FIG. 5B) and in other cases, only a portion of the end surface is planar (e.g., FIG. 5A). Although the illustrated arrangements include an end surface configuration having a single planar portion, in some implementations, the occluding portion 1218 may have multiple ramped surfaces falling within multiple planes, continuous smooth contours, or any other appropriate profile for selectively and/or differentially occluding the ejector passages 1198, 1199 upon changes in rotational position of the carousel. In addition, surfaces other than an end surface may define the variable nature of the occluding portion. For example, one or more slots in a side wall of the carousel 1210, 1210′ could include a surface that defines the variable nature of the occluding portion.

In any case, it is preferred that the obstruction portions of the carousel 1210, 1210′ at any particular point in time are diametrically opposed from one another. With such an arrangement, the obstruction portions are located along a diametrical axis, or line passing through the rotational axis, of the carousel 1210, 1210′. Accordingly, forces applied to the carousel 1210, 1210′ by the pressurized ejection gas does not apply a moment to the carousel 1210, 1210′ and, therefore, does not tend to rotate the carousel 1210, 1210′. Thus, the motor or other positioning mechanism for the carousel 1210, 1210′ does not need to resist forces applied by the pressurized ejection gas. In addition, such an arrangement permits excellent positional accuracy of the carousel 1210, 1210′ throughout the store ejection process.

The pitch control valve 1200 preferably is configured such that the carousel 1210 may be rotated to adjust the degree to which the occluding portion 1218 blocks each of the ejector passages 1198 and 1199. Accordingly, the pitch control valve 1200 may include a rotational input feature, which is driven by a drive or drive unit. In some implementations, the rotational input feature is a gear, such as a ring gear or set of annular gear teeth 1212. The annular gear teeth 1212 may be configured to engage with teeth 1236 on a driving gear 1234 driven by a drive or drive unit, such as a motor 1230. In some implementations, the motor 1230 may be used to rotate the carousel 1210. The motor 1230 may be an electric motor (e.g., a stepper motor). Rotation of the carousel 1210 may enable the occluding portion 1218 to occlude one ejector passage 1198 to a greater extent than another ejector passage 1199, and vice versa. Varying the occlusion between one ejector passage 1198 and another ejector passage 1199 may cause one ejector piston to extend at a different rate than another ejector piston. Varying extension rates between the ejector pistons 1301, 1302 may cause an aircraft store to be ejected from the aircraft at a predetermined pitch with respect to the aircraft. For example, increasing the occlusion of a forward ejector passage with respect to a rear ejector passage may cause the forward ejector piston to extend at a higher rate and/or acceleration than the rear ejector piston. In such a situation, the store would be ejected from airframe with a downward pitch (e.g., the front of the store would be further from the aircraft than the rear of the store). By rotating the carousel 1210, many different occlusion distributions between the ejector passages 1198, 1199 may be achieved and thus many different pitch configurations may be achieved for ejecting the store.

In some implementations, the pitch control valve 1200 is controlled by signals from the aircraft sensor and/or weapon control systems to select, in-flight and at any time up to immediately prior to release of the store, the optimized pitch settings to accurately and safely compensate for perturbations caused by aircraft maneuver during the store separation. In some implementations, the pitch control valve 1200 may be controlled by a pilot or other person while the aircraft is on the ground or in flight via a control interface in the cockpit or elsewhere. The motor 1230 may include one or more input ports 1232 to facilitate powering of and/or control of the pitch control valve 1200. In some implementations, the pitch control valve 1200 and/or motor 1230 may be wirelessly controlled.

In some implementations, pressurized gas that passes through pitch control valve 1200 is directed to one or more ejector pistons 1301, 1302 via one or more ejector passages 1198, 1199. The discussion of ejector piston 1301 and the features described therein may equally apply to the ejector piston 1302 and/or any other ejector piston described in the present disclosure. The ejector piston 1301 may be housed within an ejector piston housing 1304. The ejector piston 1301 may generally comprise one or more piston stages. In some implementations, the one or more piston stages may be connected to each other telescopically. In some implementations, the ejector piston 1301 includes a ram member or ram 1330. The ram 1330 may be connected to the bottom (e.g., furthest from the airframe) of the inner-most ejector stage to contact the store.

In operation, the system 10 may be used to cause ejection of a store from an associated aircraft. Preferably, the remote reservoir 1002 and local reservoir(s) 1004 are charged to a desirable pressure level on the ground or otherwise prior to the point in time in which it is desired to eject the store. If necessary or desirable, the local reservoir(s) 1004 may be “topped-off” or increased in pressure via the pressure intensifier 1006 using pressurized gas from the remote reservoir 1002. The pitch control valve 1200 may be adjusted if necessary or desired to adjust the ejection force applied to the front and rear of the store. Once a command to release the store is issued, pressurized gas from the remote reservoir 1004 is supplied to the associated ejection system 1300 by opening of the release valve 1100. Furthermore, the pistons 1301 and 1302 are extended in response to the pressurized gas and apply an ejection force to the store. Once the store is released, the release valve 1100 is closed, which permits the pistons 1301 and 1302 to retract. If desired, the local reservoir(s) 1004 may be recharged with pressurized gas from the remote reservoir 1002. This process may be repeated, if desired. For example, the remote reservoir 1002 may be configured to provide multiple recharging cycles (e.g., at least 2 or 3-10 cycles, or more).

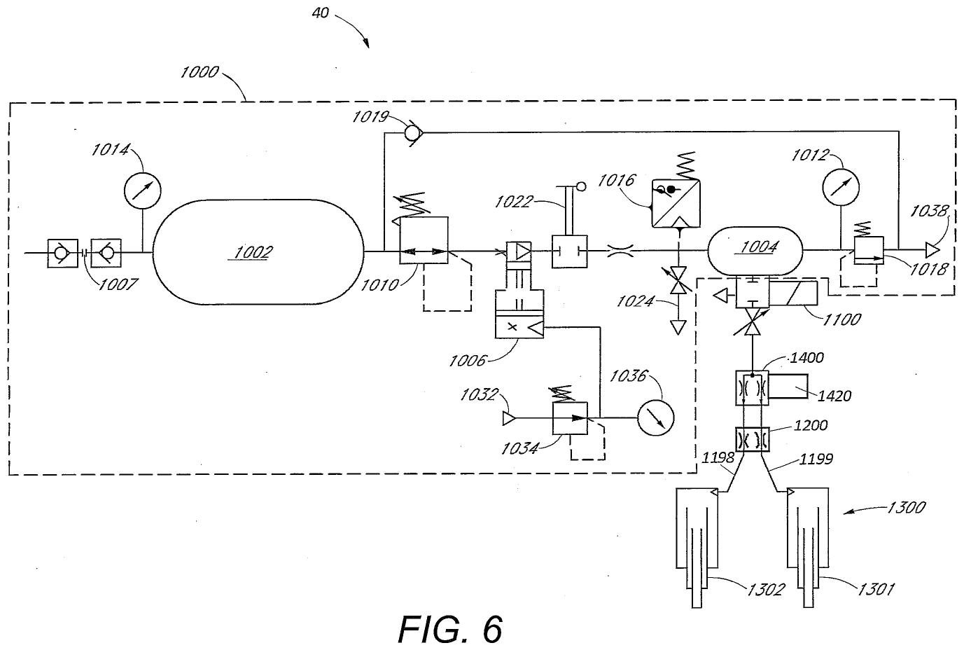

FIG. 6 illustrates an aircraft store ejector system 40 which shares many of the same or similar components and subsystems included in system 10 described above. As illustrated, some of the components and subsystems of the ejector system 40 share reference numbers with the components and subsystems of ejector system 10. In some cases, like numbers in the ejector system 40 indicate components and subsystems which are similar to or suitably constructed compared to those components and subsystems disclosed and described above with respect to ejector system 10.

The system 40 may include a control valve 1400. The control valve 1400 may comprise, for example, a ported cylinder valve. The control valve 1400 may be positioned in the fluid path between the release valve 1100 and the pitch control valve 1200. In some implementations, the release valve 1100 is positioned in the fluid path between the pitch control valve 1200 and the ejection system 1300.

The control valve 1400 may be configured to selectively occlude the fluid paths from the release valve 1100 to the pitch control valve 1200. For example, the control valve 1400 may be configured to transition between an open position, in which fluid communication (e.g., a fluid interface) between the release valve 1100 and the pitch control valve 1200 is provided, and a closed position in which the control valve 1400 closes the fluid pathway between the release valve 1100 and the pitch control valve 1200. The degree to which the control valve 1400 obscures the fluid pathway (e.g., reduces the area of interface between the interior of the upper piston housing 1240 and the one or more of the ejector passages 1198, 1199) in which it is positioned may be controlled on a continuum between fully opened and fully closed. In some implementations, the control valve 1400 is configured to obscure each of the ejector passages 1198, 1199 to the same degree as the control valve 1400 is transitioned between the open position and the closed position. In some implementations, the control valve 1400 is configured such that the degree to which each of the ejector passages 1198, 1199 is obscured as the control valve 1400 transitions between the open position and the closed position varies between the ejector passages 1198, 1199. In some such implementations, the control valve 1400 may perform the same or a similar function as that of the pitch control valve 1200.

The control valve 1400 may be controlled by signals from the aircraft sensors and/or weapon control systems to select, in-flight and at any time up to immediately prior to release of the store, the optimized degree to which the fluid from the release valve to the pitch control valve 1200 or ejector passages 1198, 1199 should be occluded to achieve optimum or controlled ejection trajectory and ejection force (e.g., based upon store properties and/or flight conditions). In some implementations, the control valve 1400 may be controlled by a pilot or other person while the aircraft is on the ground or in flight via a control interface in the cockpit or elsewhere. In some implementations, the control valve 1400 is wirelessly and/or automatically controlled. According to some variants, the control valve 1400 is controlled by a rotating force means (e.g., manual input, a motor, or a thermostatic element 1420). As illustrated in FIG. 6, the control valve 1400 may be operably coupled (e.g., mechanically coupled and/or electrically coupled) with the thermostatic element 1420. Motion of the thermostatic element 1420 may be temperature-induced. In some implementations, motion of the thermostatic element 1420 in response to changes in temperature may vary the degree of occlusion provided by the control valve 1400. In some such implementations, such a change in occlusion may compensate for changes in stored energy and flow behavior of the fluid in response to changes in temperature. Such compensation may effect a tailored and/or constant velocity of ejection and/or reaction force level in the ejection system 1300. The control valve 1400 may be used in conjunction with any of the systems 10, 20, 30 described above.

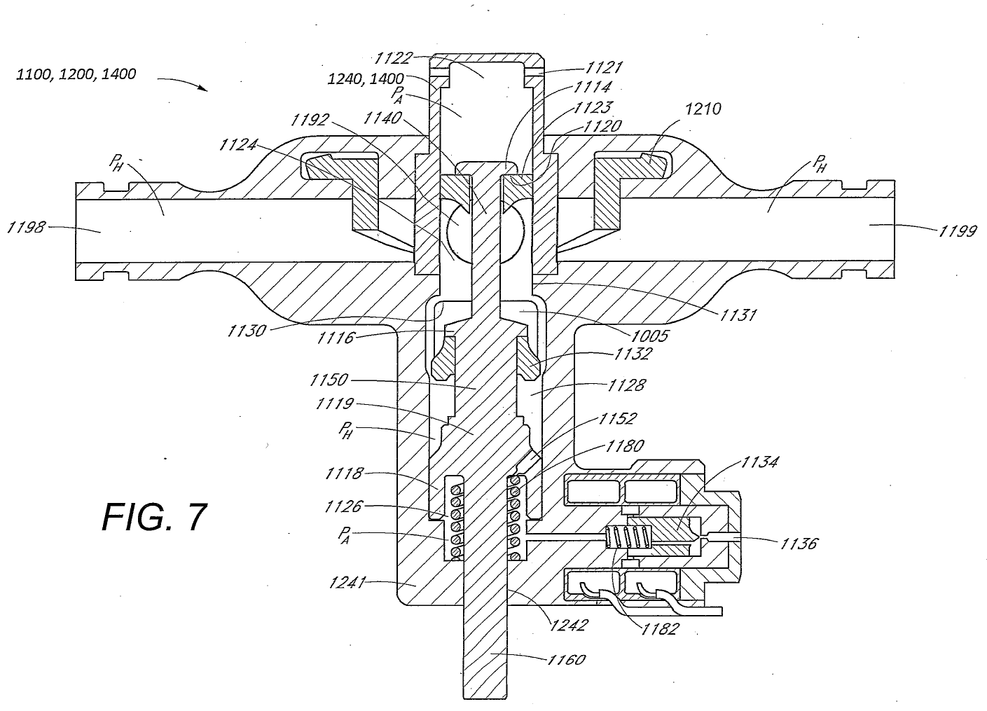

As illustrated in FIG. 7, the upper piston housing 1240 may serve as the control valve 1400. For example, the upper piston housing 1240 may serve as a ported cylinder valve. Rotation of the upper piston housing 1240 may affect the degree to which the ejector passage openings 1192, 1193 are occluded. Rotation of the upper piston housing 1240 affects the degree to which the openings 1192, 1193 are aligned with the ejector passages 1198, 1199. FIG. 7 illustrates a configuration wherein the upper piston housing 1240 (e.g., the control valve 1400) is in the fully-occluded or closed position. FIG. 4E illustrates the upper piston housing 1240 in the open position.

The control valve 1400 (e.g., the ported cylinder valve created by the upper piston housing 1240) may be used in combination with or instead of the pitch control valve 1200. For example, rotation of the upper piston housing 1240 may occlude the openings 1192, 1193 to varying degrees with respect to each other such that the fluid flow path between the valve window 1005 and the ejector passage 1198 is occluded to different degree from that of the fluid flow path between the window 1005 and the ejector passage 1199. In some implementations, the degree to which the opening 1192 is occluded or opened as the upper piston housing 1240 rotates is that same as the degree to which the opening 1193 is occluded or opened as the upper piston housing 1240 rotates.

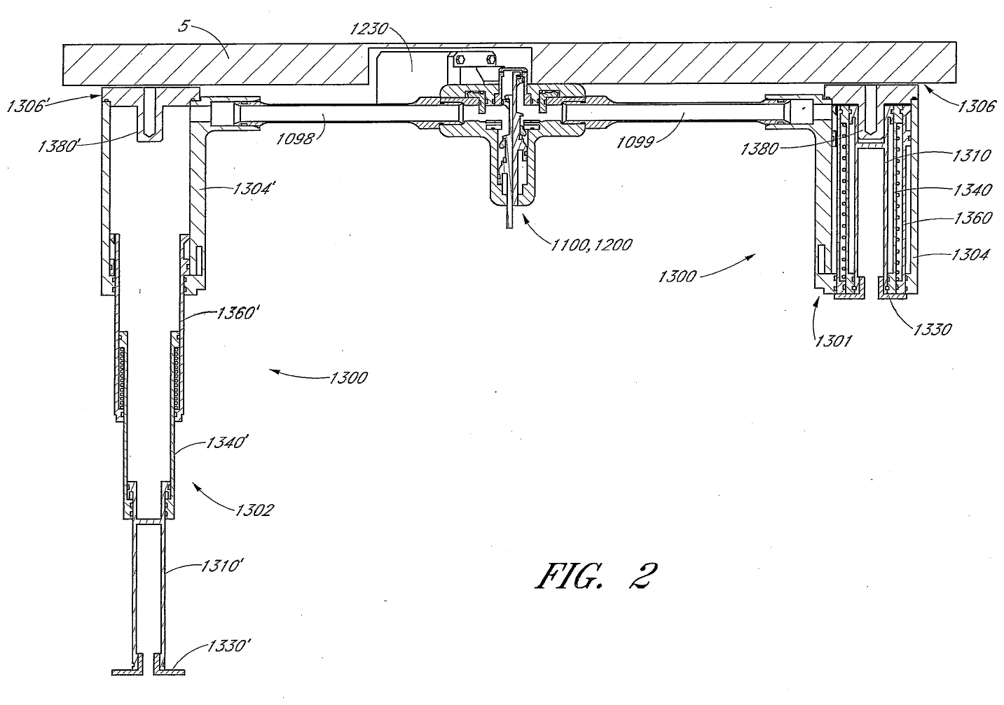

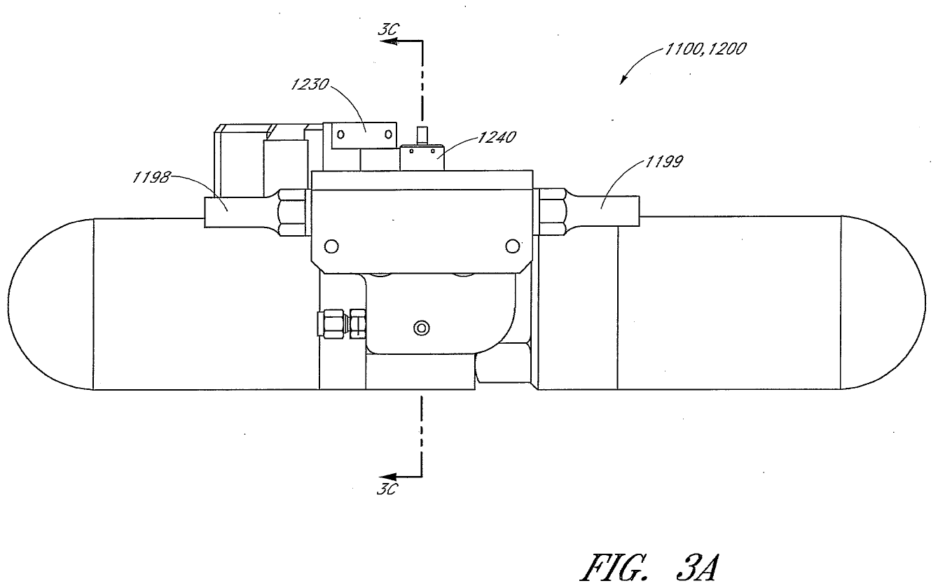

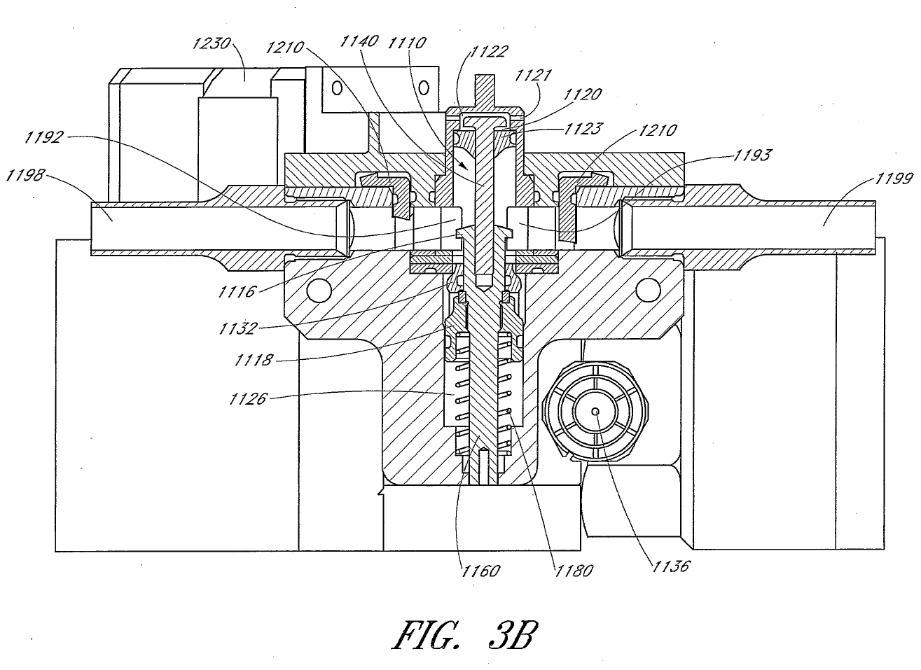

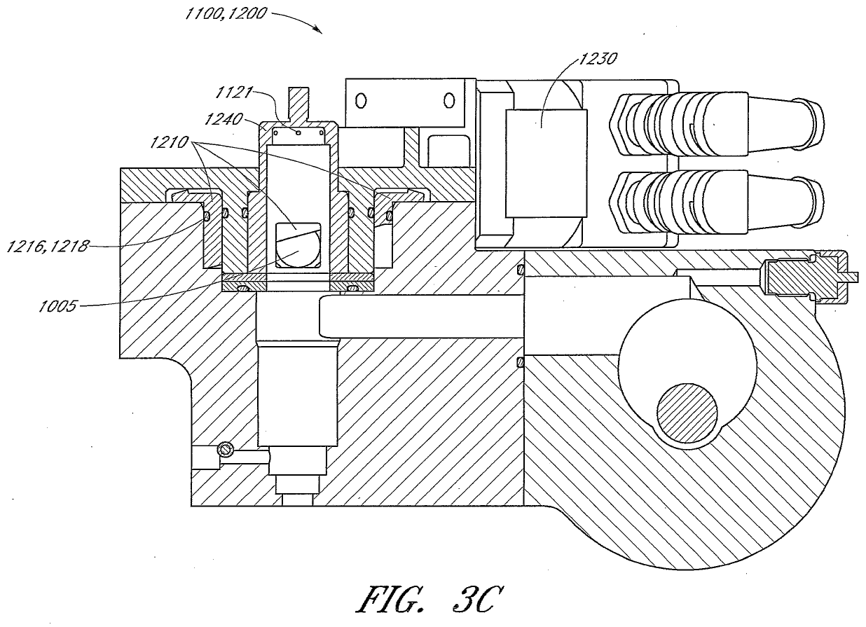

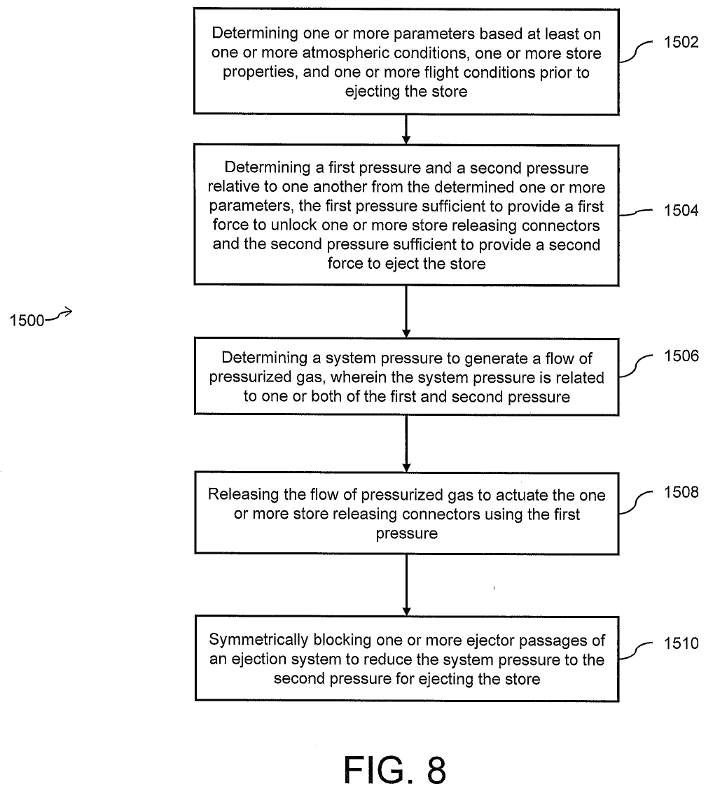

FIG. 8 is a flow diagram of a method 1500 for determining relative forces for ejecting a store of an aircraft having a pressurized gas arrangement, a main valve, a symmetrical valve, and a piston ejection system, according to various implementations of the present disclosure. Various implementations of the steps of method 1500 may be implemented by one or more of the hardware components and/or the software components described above, e.g., in reference to FIGS. 1-7. The steps of the flowcharts illustrate example implementations, and in various other implementations various steps may be rearranged, optional, and/or omitted, and/or additional blocks may be added. As mentioned herein, the suitable control system may control the ejection system 10. The control system may include any suitable sensors, processors, actuators or other typical or desirable components in addition to those illustrated herein, as will be appreciated by those skilled in the art. The control system may be a dedicated system or may be integrated with other control systems of the aircraft. The ejector system 10 may be controlled by a pilot or other crew member aboard the aircraft or may be controlled from a location remote from the aircraft. In some configurations, the method 1500 may determine and/or control forces acting to release the store relative to forces acting to eject the store. For example, in some circumstances it may be desirable to reduce forces acting to eject the store but to maintain forces acting to release the store. In some configurations, the forces acting to release the store may be greater than the forces acting to eject the store. In some configurations, the method 1500 determines or controls system pressure, which, in turn, controls the forces acting on the store. Accordingly, in some configurations the pressure acting to release the store is greater than the pressure acting to eject the store.

At step 1502, sensors and/or the weapons control system may sense, monitor, and/or determine various parameters while in-flight and at any time up to immediately prior to release of the store. In some implementations, the sensors and/or the weapons controls system may be on board the aircraft. The parameters may include atmospheric conditions, store properties, and/or flight conditions sensed prior to ejecting the store. The sensors and/or weapons controls system may sense, monitor, and/or determine the parameters continuously and/or at various intervals. For example, the parameters may be gathered at any suitable interval, which may include multiple times per second or longer intervals. Longer intervals may be intervals of 1 second or greater in length, such as between 1 second to 180 seconds, between 1 second to 150 seconds, between 1 second and 120 seconds, between 1 second and 90 seconds, between 1 second and 60 seconds, between 1 second and 45 seconds, between 1 second and 30 seconds, between 1 second and 15 seconds, between 1 second and 10 seconds, between 1 second to 5 seconds, between 1 second to 3 seconds, or between 1 second to 2 seconds. Any one of the valves 1100, 1200, 1400 may be controlled by signals transmitted from the aircraft sensors and/or the weapon controls system to optimize the degree to which the fluid to the valves 1100, 1200, 1400, or ejector passages 1198, 1199 should be occluded to achieve optimum or controlled ejection trajectory and ejection force (e.g., based upon atmospheric conditions, store properties and/or flight conditions).

At step 1504, a determination is made as to a first pressure and a second pressure, which may be relative to one another. In some implementations, the first and second pressure may be determined from the parameters of step 1502 by the control system, a processor of the control system, and/or another processor. The control system may be on board the aircraft or at a location remote from the aircraft. The first pressure may be sufficient to provide a first force to unlock the store securing features mentioned herein, and the second pressure may be sufficient to provide a second force to eject the store. In some implementations, the first pressure may be sufficient to cause the valve piston 1110 to engages the main valve poppet 1132, such as at the shoulder 1116. The shoulder 1116 may be positioned at the border between the top portion 1140 and intermediate portion 1150 of the valve piston 1110. The first pressure may cause the downward movement of the valve piston 1110 to bring the shoulder 1116 into contact with the main valve poppet 1132, as illustrated in FIG. 4D. Thus, the valve piston 1110 and main valve poppet 1132 create the lost motion mechanism. The distance between the shoulder 1116 and the main valve poppet 1132 may provide a delay in actuation of the main valve poppet 1132 and the release of pressurized gas to the ejection system 1300 to ensure that the store securing features have been released prior to the ejection of the store.

At step 1506, the method 1500 includes determining a system pressure to generate a flow of pressurized gas from the local reservoir(s) 1004 to the ejections system 1300. The control system, processor of the control system, and/or another processor may determine the system pressure. The system pressure may be related to one and/or both of the first and second pressure such that the system pressure is sufficient to be distributed and provide enough force for the first pressure and/or second pressure.

At step 1508, the method 1500 includes releasing the flow of pressurized gas to actuate the store securing features using the first pressure. The store securing features may include sway braces configured to stabilize the store. In some implementations, the store securing features are hooks holding the store to the aircraft.

At step 1510, the method 1500 includes symmetrically blocking the ejector passages 1198, 1199 to reduce the system pressure to the second pressure for ejecting the store. In some implementations, the flow of pressurized gas may be apportioned between the ejector passages 1198, 1199. For example, the pitch control valve 1200 discussed above may be configured such that the carousel 1210 may be rotated to adjust the degree to which the occluding portion 1218 blocks each of the ejector passages 1198 and 1199. Additionally or alternatively, the control valve 1400 may also be configured to selectively occlude the fluid paths from the release valve 1100 to the pitch control valve 1200. For example, the control valve 1400 may be configured to transition between an open position, in which fluid communication (e.g., a fluid interface) between the release valve 1100 and the pitch control valve 1200 is provided, and a closed position in which the control valve 1400 closes the fluid pathway between the release valve 1100 and the pitch control valve 1200. The degree to which the control valve 1400 obscures the fluid pathway (e.g., reduces the area of interface between the interior of the upper piston housing 1240 and the one or more of the ejector passages 1198, 1199) in which it is positioned may be controlled on a continuum between fully opened and fully closed. The variable obstruction apportioning the gas flow between the ejector passages 1198, 1199 may cause one ejector piston to extend at a different rate than another ejector piston. Varying extension rates between the ejector pistons 1301, 1302 may cause the store to be ejected from the aircraft at a predetermined pitch with respect to the aircraft. For example, increasing the occlusion of a forward ejector passage with respect to a rear ejector passage may cause the forward ejector piston to extend at a higher rate and/or acceleration than the rear ejector piston. In such a situation, the store would be ejected from airframe with a downward pitch (e.g., the front of the store would be further from the aircraft than the rear of the store).

In some implementations, the symmetrical blocking is configured to allow a reduction in the second pressure acting on the ejector pistons 1301, 1302 in fluid communication with the ejector passages 1198, 1199 while preserving the flow of the first pressure to actuate the one or more store releasing connectors at a relatively greater pressure than the pressure acting on the ejector pistons 1301, 1302. The symmetrical blocking may reduce the second pressure acting on the ejector pistons 1301, 1302 to reduce a peak force and/or acceleration acting on the store.

Although this invention has been disclosed in the context of certain preferred implementations and examples, it will be understood by those skilled in the art that the present invention extends beyond the specifically disclosed implementations to other alternative implementations and/or uses of the invention and obvious modifications and equivalents thereof. In particular, while the present aircraft store ejector system, components and methods have been described in the context of particularly preferred implementations, the skilled artisan will appreciate, in view of the present disclosure, that certain advantages, features and implementations of the system may be realized in a variety of other applications, many of which have been noted above. Additionally, it is contemplated that various implementations and features of the invention described may be practiced separately, combined together, or substituted for one another, and that a variety of combination and subcombinations of the features and implementations may be made and still fall within the scope of the invention. For example, the ejection system 1300 may be used in combination with one or more of the re-pressurization systems 1000, 2000, and/or 3000 or with an alternative re-pressurization system not disclosed in the present disclosure. Thus, it is intended that the scope of the present invention herein disclosed should not be limited by the particular disclosed implementations described above, but should be determined only by a fair reading of the claims.

Any portion of any of the steps, processes, structures, and/or devices disclosed or illustrated in one implementation in this disclosure may be combined or used with (or instead of) any other portion of any of the steps, processes, structures, and/or devices disclosed or illustrated in a different implementation or flowchart. The implementations described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described may be incorporated in the example methods and processes. For example, one or more additional operations may be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems may generally be integrated together in a single product or packaged into multiple products. Additionally, some implementations are within the scope of this disclosure.

Conditional language, such as “may,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain implementations, as the context may dictate, the term “generally parallel” may refer to something that departs from exactly parallel by less than or equal to 20°. All ranges are inclusive of endpoints.

Several illustrative implementations of aircraft store ejector system, components and methods have been disclosed. Although this disclosure has been described in terms of certain illustrative implementations and uses, other implementations and other uses, including implementations and uses which do not provide all of the features and advantages set forth herein, are also within the scope of this disclosure. Components, elements, features, acts, or steps may be arranged or performed differently than described and components, elements, features, acts, or steps may be combined, merged, added, or left out in various implementations. All possible combinations and subcombinations of elements and components described herein are intended to be included in this disclosure. No single feature or group of features is necessary or indispensable.

Certain features that are described in this disclosure in the context of separate implementations may also be implemented in combination in a single implementation. Conversely, various features that are described in the context of a single implementation also may be implemented in multiple implementations separately or in any suitable subcombination. Moreover, although features may be described above as acting in certain combinations, one or more features from a claimed combination may in some cases be excised from the combination, and the combination may be claimed as a subcombination or variation of a subcombination.

Further, while illustrative implementations have been described, any implementations having equivalent elements, modifications, omissions, and/or combinations are also within the scope of this disclosure. Moreover, although certain aspects, advantages, and novel features are described herein, not necessarily all such advantages may be achieved in accordance with any particular implementation. For example, some implementations within the scope of this disclosure achieve one advantage, or a group of advantages, as taught herein without necessarily achieving other advantages taught or suggested herein. Further, some implementations may achieve different advantages than those taught or suggested herein.

Some implementations have been described in connection with the accompanying drawings. The figures may or may not be drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components may be added, removed, and/or rearranged. Further, the disclosure herein of any particular feature, aspect, method, property, characteristic, quality, attribute, element, or the like in connection with various implementations may be used in all other implementations set forth herein. Additionally, any methods described herein may be practiced using any device suitable for performing the recited steps.

For purposes of summarizing the disclosure, certain aspects, advantages, and features of the inventions have been described herein. Not all, or any such advantages are necessarily achieved in accordance with any particular implementation of the inventions disclosed herein. In many implementations, the devices, systems, and methods may be configured differently than illustrated in the figures or description herein. For example, various functionalities provided by the illustrated modules may be combined, rearranged, added, or deleted. In some implementations, additional or different processors or modules may perform some or all of the functionalities described with reference to the implementations described and illustrated in the figures. Many implementation variations are possible. Any of the features, structures, steps, or processes disclosed in this specification may be included in any implementation.

In summary, various implementations of aircraft store ejector system, components and methods have been disclosed. This disclosure extends beyond the specifically disclosed implementations to other alternative implementations and/or other uses of the implementations, as well as to certain modifications and equivalents thereof. Moreover, this disclosure expressly contemplates that various features and aspects of the disclosed implementations may be combined with, or substituted for, one another. Accordingly, the scope of this disclosure should not be limited by the particular disclosed implementations described above, but should be determined only by a fair reading of the claims.

What is claimed is:

1. A method of ejecting a store from an aircraft, comprising:
determining one or more parameters based at least on one or more atmospheric conditions, one or more store properties, and one or more flight conditions prior to ejecting the store;
determining a first pressure and a second pressure relative to one another from the determined one or more parameters, the first pressure sufficient to provide a first force to unlock one or more store releasing connectors and the second pressure sufficient to provide a second force to eject the store;
determining a system pressure to generate a flow of pressurized gas, wherein the system pressure is related to one or both of the first and second pressure;
releasing the flow of pressurized gas to actuate the one or more store releasing connectors using the first pressure; and
symmetrically blocking one or more ejector passages of an ejection system to reduce the system pressure to the second pressure for ejecting the store.

2. The method of claim 1, wherein a control system is configured to determine the first and second pressures from the one or more parameters.

3. The method of claim 2, wherein the control system is on board the aircraft.

4. The method of claim 1, further comprising apportioning the flow of pressurized gas between a first ejector passage and a second ejector passage, wherein the apportioning variably obstructs the first ejector passage and the second ejector passage to cause a first ejector piston to extend at a different rate than a second ejector piston, and wherein the first and second ejector pistons act on the store to eject the store from the aircraft.

5. The method of claim 1, further comprising delaying an opening of a main valve following the actuation of the one or more store releasing connectors.

6. The method of claim 1, wherein the symmetrical blocking is configured to allow a reduction in the second pressure acting on or more ejector pistons in fluid communication with the one or more ejector passages while preserving the flow of the first pressure to actuate the one or more store releasing connectors.

7. The method of claim 6, wherein the symmetrical blocking reduces the second pressure acting on one or more ejector pistons to reduce a peak force or acceleration acting on the store.

8. A computer implemented method, performed by an aircraft store ejector system comprising one or more hardware processors executing program instructions, the method comprising:
detecting one or more flight parameters via one or more sensors;
determining from the one or more flight parameters a first pressure sufficient to provide a first force to act on a piston for actuating one or more store releasing connectors and a second pressure sufficient to provide a second force to act on one or more ejector pistons for ejecting a store;
selecting a system pressure, wherein the system pressure is related to one or both of the first pressure and the second pressure; and
reducing the second pressure received by an ejection system, the ejection system comprising a first ejector passage and a second ejector passage in fluid communication with a respective one of a first ejector piston and a second ejector piston.

9. The method of claim 8, wherein the one or more flight parameters comprise at least one or more atmospheric conditions, store properties, and one or more flight conditions, and wherein the store properties comprise a weight of the store.

10. The method of claim 8, further comprising using the first pressure to actuate the one or more store releasing connectors.

11. The method of claim 8, further comprising using the reduced second pressure to eject the store from the aircraft.

12. The method of claim 8, further comprising moving a main valve carried by the piston and configured to selectively separate a source of pressurized gas from the first ejector passage and the second ejector passage, wherein moving the main valve to an open position allows a flow of pressurized gas from the source of pressurized gas to enter the first ejector passage and the second ejector passage.

13. The method of claim 8, further comprising adjusting a control valve, wherein adjusting the control valve comprises rotating the control valve about a first axis to alter a position of a first opening with respect to the first ejector passage and a second opening with respect to the second ejector passage to adjust a flow of a pressurized gas provided to the first ejector passage and the second ejector passage.

14. The method of claim 8, wherein the system pressure is provided by a pressurized gas source.

15. A method of ejecting a store from an aircraft, comprising:
detecting one or more flight parameters of the aircraft;
determining from the one or more flight parameters a first pressure sufficient to provide a first force for actuating one or more store releasing connectors;
determining from the one or more flight parameters a second pressure sufficient to provide a second force for ejecting the store;
selecting a system pressure based at least in part on the first force for actuating the one or more store releasing connectors;
using the system pressure to actuate the one or more store releasing connectors;
reducing the system pressure to a reduced pressure based at least in part on the second force for ejecting the store; and
using the reduced pressure to eject the store from the aircraft.

16. The method of claim 15, wherein a control system is configured to determine the first and second pressures from the one or more flight parameters, and wherein the control system is on board the aircraft.

17. The method of claim 15, wherein the one or more flight parameters comprise at least one or more atmospheric conditions, store properties, and one or more flight conditions, and wherein the store properties comprise a weight of the store.

18. The method of claim 15, further comprising apportioning the reduced pressure between a first ejector passage and a second ejector passage, wherein the apportioning variably obstructs the first ejector passage and the second ejector passage to cause a first ejector piston to extend at a different rate than a second ejector piston, and wherein the first and second ejector pistons act on the store to eject the store from the aircraft.

19. The method of claim 15, further comprising delaying an opening of a main valve following the actuation of the one or more store releasing connectors.

20. The method of claim 15, wherein reducing the system pressure to a reduced pressure allows a reduction in the second pressure acting on or more ejector pistons in fluid communication with one or more ejector passages while preserving a flow of the first pressure to actuate the one or more store releasing connectors, and wherein the reduced pressure reduces the second pressure acting on the one or more ejector pistons to reduce a peak force or acceleration acting on the store.
